(19) United States
(12) Patent Application Publication
(10) Pub. No.: US 2010/0264218 A1
(43) Pub. Date: Oct. 21, 2010

(54) DATA CARRIER SYSTEM AND METHOD

(75) Inventors: Dean Daniels, Rosement, MN (US); William Stifle, Rogers, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Datakey Electronics, Inc, Savage, MN (US)

(21) Appl. No.: 12/675,719

(22) PCT Filed: Aug. 29, 2008
(86) PCT No.: PCT/US08/74888

§ 371 Date: Jul. 7, 2010

Related U.S. Application Data
(60) Provisional application No. 60/968,670, filed on Aug. 29, 2007.

(51) Int. Cl. G06K 7/06

(52) U.S. Cl. 235/441

(57) ABSTRACT

An electronic token system includes a token receptacle, having a housing with a receiver channel, and a token for insertion in the receiver channel on an insertion path defined by one or more receiver-channel guide surfaces. The token includes a data exchange circuit and a plurality of electrical contacts in a planar array exposed on a contact surface of the token in electrical coupling with the data exchange circuit. A plurality of spring-loaded probe contacts are mounted in the token receptacle, the probe contacts each having a plunger movable by spring action in a direction generally orthogonal to the planar array of electrical contacts on an inserted token and having a contact tip for receipt at a corresponding one of the electrical contacts in the planar array. A stop is provided on the token for contacting a travel limiter on the token receptacle, the stop and travel limiter being configured to define full insertion of the token into the receiver channel.

### CROSS-REFERENCE TO RELATED APPLICATIONS(S)

This application claims priority to U.S. Provisional Patent Application No. 60/968,670, filed Aug. 29, 2007, the subject matter of which is hereby incorporated by reference herein in its entirety.

### FIELD OF THE INVENTION

The present disclosure relates generally to an electronic data carrier system. Particularly, the present disclosure relates to apparatus and methods for electronic data carriers and receptacles therefor. More particularly, the present disclosure relates to apparatus and methods for an edge connector electronic data carrier system comprising a token and token receptacle, wherein contacts on the token slidingly engage with spring-loaded probes of the token receptacle.

### BACKGROUND OF THE INVENTION

Electronic token data carrier systems have been used in many applications and have proven to be a source for portable information solutions. For example, electronic token systems have been used in data logging applications wherein a portable electrical/electronic token device stores user and/or other information for transport of data to/from a remote station; in access control applications where a portable token device stores information to be verified by an access control program or system; in cashless vending or cash token applications wherein a portable electrical/electronic token device stores a value (e.g., cash value or number of credits, etc.) that is decremented after, for example, vending a product, and can be recharged with additional value; and in security applications wherein a portable electrical/electronic token device stores personal identification information that is valid only when the electrical/electronic token device is being used by the owner or authorized personnel of the electrical/electronic token device.

Prior electronic token data carrier systems include various embodiments of electrical/electronic token devices and electrical token receptacles disclosed in U.S. Pat. No. 4,752,679, entitled “RECEPTACLE DEVICE,” issued on Jun. 21, 1988; U.S. Pat. No. 4,659,915, entitled “RECEPTACLE DESIGN FOR USE WITH ELECTRONIC KEY-LIKE DEVICE,” issued on Apr. 21, 1987; U.S. Pat. No. 4,522,456, entitled “ELECTRONIC TAG RECEPTACLE AND READER,” issued on Jun. 11, 1985; U.S. Pat. No. 4,620,088, entitled “RECEPTACLE DESIGN FOR USE WITH ELECTRONIC KEY-LIKE DEVICE,” issued on Oct. 28, 1986; U.S. Design Pat. D345,686, entitled “ELECTRICAL INFORMATION KEY,” issued on Apr. 5, 1994; U.S. Pat. No. 4,578,573, entitled “PORTABLE ELECTRONIC INFORMATION DEVICES AND METHOD OF MANUFACTURE,” issued on Mar. 25, 1986; U.S. Pat. No. 4,549,076, entitled “ORIENTATION GUIDE ARRANGEMENT FOR ELECTRONIC KEY AND RECEPTACLE COMBINATION,” issued on Oct. 22, 1985; U.S. Pat. No. 4,436,993, entitled “ELECTRONIC KEY,” issued on Mar. 13, 1984; U.S. Pat. No. 5,073,703, entitled “APPARATUS FOR ENCODING ELECTRICAL IDENTIFICATION DEVICES BY MEANS OF SELECTIVELY FUSIBLE LINKS,” issued on Dec. 17, 1991; U.S. Design Pat. D291,897, entitled “IDENTIFICATION TAG,” issued on Sep. 15, 1987; U.S. Pat. No. 4,326,125, entitled “MICROELECTRONIC MEMORY KEY WITH RECEPTACLE AND SYSTEMS THEREFOR,” issued on Apr. 20, 1982; and U.S. Pat. No. 4,297,569, entitled “MICROELECTRONIC MEMORY KEY WITH RECEPTACLE AND SYSTEMS THEREFOR,” issued on Oct. 27, 1981; all of which are assigned to Datakey Electronics, Inc., the assignee of the present application, and all of which are hereby incorporated herein by reference in their entirety.

The above-referenced electronic token systems disclose electrical/electronic token devices and receptacles. In general, a circuit or electrical operation system is activated by use of a portable token device, which is inserted into a receptacle or the like, to make electrical contact or connection with the outside circuit or the electrical operation system. Such electrical contact or connection is generally made by rotating the token device after the token is fully inserted into the receptacle, whereby a plurality of cantilever spring contacts or “bent metal” contacts of the receptacle mate with contacts of the token device. Electrical pathways or wires/traces in the receptacle electrically connect the cantilever spring contacts to an interface of the receptacle. The interface carries electrical signals from the token device to the outside circuit or electrical operation system.

It has been recognized that the bent metal and/or flexible or resilient metal contacts of the token device and the receptacle are subject to wear and tear not only because of the mechanical contact, but also because the contacts are exposed to an outside environment without protection. Typically, in bent metal contact systems the insertion direction of the of the token device is ninety (90) degrees, or orthogonal, from the spring deflection direction of the cantilever spring contacts of the receptacle.

In contrast, however, in systems with spring-loaded probes, the mating direction of the token device is axially-oriented with the spring compression direction (assuming that spring-loaded probe includes the standard spiral wound spring that is co-axial with the probe). There are several reasons that spring-loaded probe systems can be desirable over bent metal contact systems, including but not limited to, they have minimized occupied area, they have structures that can be overmolded in plastic, they can be placed on circuit boards with standard printed circuit board populating techniques, they can be built to have their operation resist infiltration of dirt, debris, viscous liquids, etc. and are much less vulnerable than bent metal contacts because fewer crucial components are exposed, and they encapsulate all the area they need to facilitate their motion.

Generally, a spring-loaded probe consists of a barrel, plunger, and spring. There are several spring-loaded probe manufacturing techniques that “bias” the plunger against the barrel of the probe and enhance electrical contact between the plunger and the barrel. Such techniques tend to increase the cost, complexity, and size of the spring-loaded probe, which is undesirable in an electronic token data carrier application.

The various embodiments described herein improve upon the typical applications for spring-loaded probes, and particularly, improve upon electronic token data carrier systems and concepts using novel and advantageous spring-loaded probe electronic token data carrier token devices and receptacles and methods related thereto. There exists a need in the art for rugged electronic token data carrier systems with cleanable receptacles having good token retention.

### BRIEF SUMMARY OF THE INVENTION

The various embodiments of the present disclosure provide solutions for, among other things, the problems identified above. The present disclosure, in one embodiment, relates to an electronic token system for data exchange with a host device. The electronic token system includes a token receptacle operably connected to the host device and having a housing with a receiver channel and a portable token for removable insertion in the receiver channel on an insertion path defined by one or more receiver-channel guide surfaces. The token includes a data exchange circuit supported in the enclosure and a plurality of electrical contacts in a planar array exposed on a contact surface of the token, in operable electrical coupling with the data exchange circuit. A plurality of spring-loaded probe contacts are mounted in the token receptacle, each of the probe contacts having a plunger movable by spring action in a direction generally orthogonal to the planar array of electrical contacts on an inserted token and having a contact tip for receipt at a corresponding one of the electrical contacts in the planar array. A stop is provided on the portable token for contacting a travel limiter on the token receptacle, the stop and travel limiter being dimensionally configured to define full insertion of the token into the receiver channel at a position along the insertion path at which each of the contact tips of the plurality of spring-loaded contacts is spring driven for engagement at a corresponding one of the electrical contacts in the planar array. In one embodiment, the token is configured to, upon insertion into either the proximal or distal end of the insertion path, clear debris from the receiver channel by pushing the debris out the other of the proximal or distal end of the insertion path.

In another embodiment of the present disclosure, the contact tips of the plurality of spring-loaded probe contacts is substantially hemi-spherical having a radius r. Even further, the spring-loaded probe contacts can be mounted in the token receptacle such that only a portion of the contact tip having an axial length of less than r extends beyond the surface of the housing in the receiver channel.

The present disclosure, in another embodiment, relates to an electronic token system as described above, wherein the token slidingly engages the receiver channel and, upon insertion of the token into the receiver channel, the plurality of electrical contacts of the token create side-loading of the respective, corresponding spring-loaded probe contacts to create an enhanced electrical contact between the components of each spring-loaded probe.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a perspective view of an electronic token data carrier system in accordance with one embodiment of the present disclosure, wherein the token has been slidingly inserted into the token receptacle.

FIG. 2 is a perspective view of an electronic token data carrier system in accordance with one embodiment of the present disclosure, wherein the token is not yet inserted into the token receptacle in an activation position.

FIG. 3 is a perspective view of a token receptacle in accordance with one embodiment of the present disclosure, illustrating the underneath side of the token receptacle.

FIG. 4 is an exploded view of a token receptacle in accordance with one embodiment of the present disclosure and a possible host device for the token receptacle.

FIG. 5 is a perspective view of a token device in accordance with one embodiment of the present disclosure, illustrating the underneath side of the token device and the contacts thereon.

FIG. 6 is a partial, cross-sectional, perspective view of a spring-loaded probe contact positioned in the token receptacle according to one embodiment of the present disclosure.

### DETAILED DESCRIPTION

The present disclosure relates generally to an electronic data carrier system, and particularly, apparatus and methods for electronic data carriers and receptacles therefor. More particularly, the present disclosure relates to apparatus and methods for an electronic data carrier system comprising an electrical/electronic token device and token receptacle having generally an orthogonal relationship between the travel of a spring-loaded probe contact and the direction of the token insertion.

The present disclosure provides various embodiments of an electronic token data carrier system having an electrical/electronic token device and an intelligent token receptacle, wherein the system is capable of performing a transaction and/or data transfer between the token device and token receptacle after the token device is inserted into the token receptacle and placed to a predetermined, full insertion, activation position.

The various embodiments of the present disclosure can be used in many applications, for example, with secure communications products that secure governmental communications/information. If the data carrier and the equipment it is configured to mate with are maintained physically separated, there is potentially minimal, or no, security risk of discovery of the equipment's secure algorithms. Other exemplary applications where the various embodiments of the present disclosure can be used include, but are not limited to, a data logging application for transport of data to/from a remote station, for access control to electronic systems or to facilities, for carrying a cash value (e.g., cashless vending), and for crypto-ignition keys, or CIKs.

In a data logging operation, the system reads/writes information from/to the token, and the user transports data to/from a remote station via a token receptacle. In an access control operation, the system determines whether the token is one of the permitted, or allowed, tokens. If so, the system outputs a logic command, such as an administer-specified length of access time, etc. This application can be used for locks and gates, etc. In a cashless vending operation, the system stores an amount of value (e.g., cash value, or number of credits, etc.) on the token and decrements the value on the token after each vending operation. Once the cash, credit, etc. is used up, additional cash, credits, etc. can be recharged onto the token in a similar operation. During a cashless vending operation, a user and/or the system may also activate a dispenser, open a control, and activate the control for a length of time.

It is appreciated that the electronic token systems of the present disclosure are not limited by the term “token” or its definition. The systems of the present disclosure may also be referred to as electronic lock or locking systems, data logging systems, cashless vending systems, data decrementing systems, data access control systems, UK systems, etc.

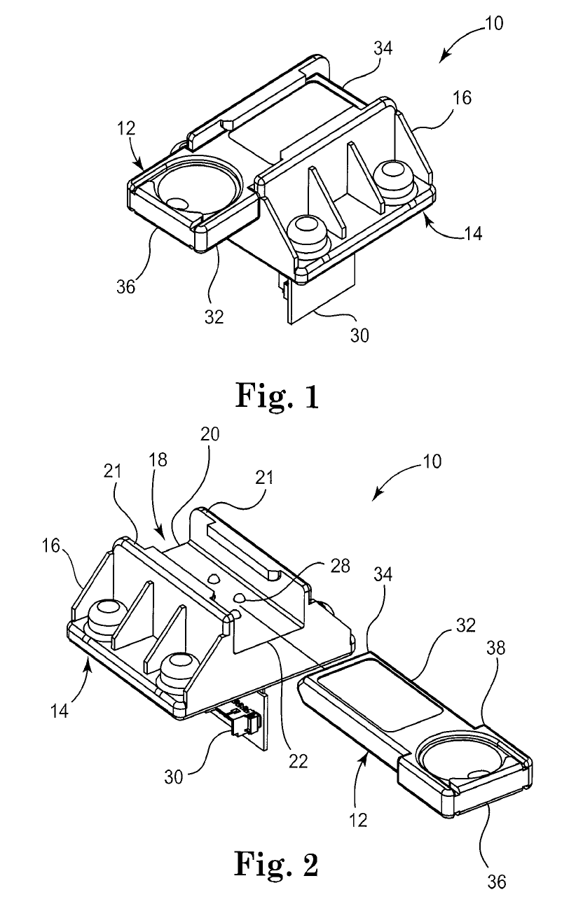

FIGS. 1 and 2 illustrate one embodiment of an edge connector electronic data carrier system 10 according to the present disclosure. The edge connector data carrier system 10 includes an electrical/electronic token device 12 and a token receptacle 14. A token receptacle 14 includes a housing 16 having a channel, slot, or opening 18 configured and arranged to receive the token 12 in a sliding engagement. The channel 18 has a distal end 20 and a proximal end 22 and at least one guide surface 21 that, by sliding interaction with a portion of the token 12, serves to define an insertion path for the token 12. In one embodiment, as illustrated in FIGS. 1 and 2, the channel 18 may be open-ended, such that both the distal end 20 and the proximal end 22 are open, or otherwise allow insertion of the token 12 and removal of debris from the channel 18. In the exemplary embodiment illustrated in FIGS. 1 and 2, the channel 18 may be generally configured to receive a token 12 that is generally rectangular in shape. Here, channel 18 has a pair(s) of opposed, parallel guide surfaces 21 that define a linear insertion path. Other configurations of guides surfaces 21 and mating portions of the token 12 may define other, non-linear insertion paths. The primary requirement is that the end of the insertion path (“full insertion”) leads to the desired electrical connection between the respective, corresponding contacts of the token 12 and token receptacle 12. Thus, it is recognized that the channel 18 could also be configured to receive tokens having a shape other than generally rectangular, such as but not limited to, square tokens, triangular tokens, curved tokens, etc. As shown in the figures, the channel 18 can also be configured such that a portion of the token 12, when inserted into the channel 18, is exposed; however, it is recognized that the channel 18 can also be configured as a “tunnel” or closed pocket to substantially fully enclose the token 12 when the token 12 is inserted into the channel 18. In some embodiments, the channel 18 may further be configured such that the token 12 can be inserted from either the distal end 20 or the proximal end 22 of the channel 18 (e.g., reversible), thereby increasing ease of use. In other embodiments, the channel 18 may shaped, keyed, or otherwise configured such that the token 12 can only be inserted from either the distal end 20 or proximal end 22 of the channel, guaranteeing insertion by the user from only one end. In some embodiments, a rib, flange or other feature of guide surface(s) 21 helps hold the token 12 to the desired insertion path.

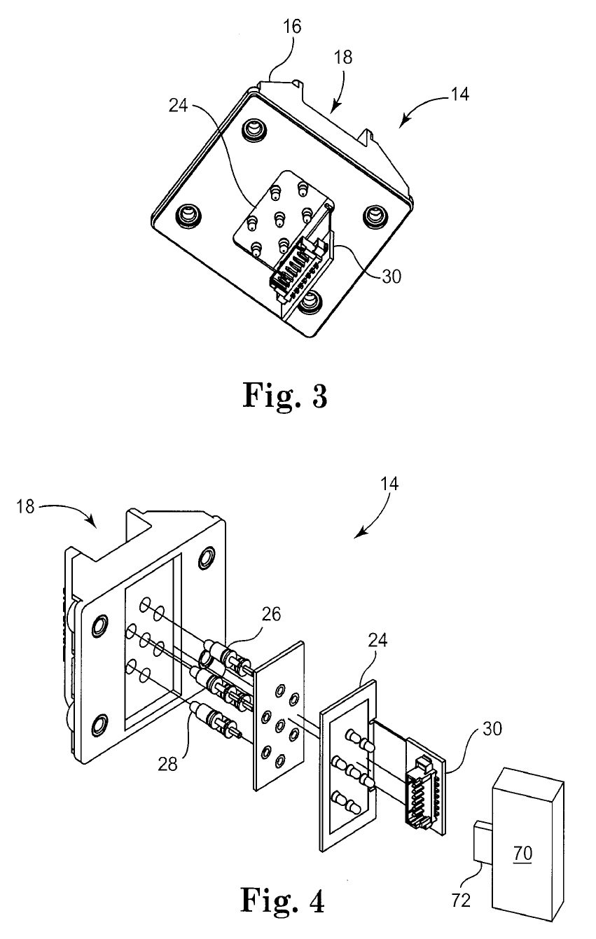

As shown in FIGS. 3 and 4, a token receptacle 14 also includes a circuit, e.g., a printed circuit board (“PCB”) 24. The circuit 24 is configured and arranged to be mounted integrally with the housing 16. However, as can be seen in the figures, in one embodiment, a portion of the PCB may be exposed on the underside of the housing 16. The circuit 24 includes electrical traces or pathways, a processor (e.g., a suitable CPU), and at least one embedded application (or other data processing logic), addressable I/O lines, and/or communication bus/interface, that are operable for data exchange with the token device 12. The CPU, addressable I/O lines, and electrical traces or pathways can be any suitable CPU, addressable I/O lines and/or communication bus/interface, and electrical wires known in the electrical and computer art. The at least one embedded application can be any type of user application, such as reader/writer modules, a transaction control program (e.g., for a purchase), etc., that are known in the electrical and computer art.

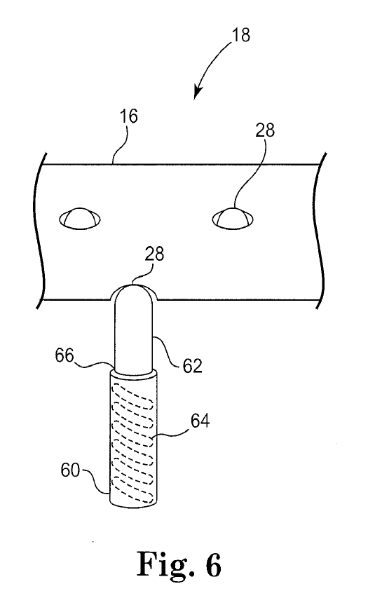

One or more spring-loaded probe contacts 26 are coupled to the circuit 24 in a desired pattern. Spring-loaded probes can be desirable over bent metal contact systems for several reasons, including but not limited to, spring-loaded probes have minimized occupied area, they have structures that can be overmolded in plastic, they can be placed on circuit boards with standard printed circuit board populating techniques, including solderless techniques, they can be built to resist dirt, debris, viscous liquids, etc. and are much less vulnerable than bent metal contacts because fewer crucial components are exposed, and the barrel encapsulates all the area needed to facilitate motion of the plunger. As can be seen in FIG. 6, a spring-loaded probe 26 generally comprises a barrel 60, a plunger 62, and a spring 64. The plunger has a contact tip 28 that is generally round, or semi-circular, in shape. The shape of the barrel 60 and the plunger 62 are configured to define an enhanced contact surface 66 caused by the slight off-axis positioning of the plunger with respect to the barrel created by side-loading the probe. This helps ensure good electrical contact extending from a contact tip 28 at the distal end of the plunger 62 to the barrel 60 in which it is received, not withstanding the relative motion. For example, such a spring-loaded probe is available from IDI International as model 101377. The spring-loaded probes 26 may be overmolded and integrated into the housing 16 such that only a portion of the round tips of the plungers 28 are exposed in the channel 18 of the token receptacle 14. Specifically, according to one embodiment illustrated in FIG. 6, the spring-loaded probes 26 may be overmolded and integrated into the housing 16 such that when a token 12 is slidingly inserted into the channel 18 of the token receptacle 14, the plungers of the spring-loaded probes 26 are pushed down, or otherwise depressed into the barrel of the probes by less than the radius of the generally round, or semi-circular, contact tip 28. As a result, the rounded tip of the plunger 28 does not pass into the barrel of the spring-loaded probe 26. Therefore, a consistent, minimal gap is maintained between the barrel and the plunger, keeping foreign debris out of the inside of the barrel. This can be advantageous, particularly in harsh environments, to the functionality of the token receptacle 14.

In some embodiments, the token receptacle 14 may include an interface 30 for interfacing an external host device 70 or operation system. The device 70 may have its own interface connector 72. As shown in FIGS. 3 and 4, the interface 30 is coupled or integrated to the token receptacle 14 and is electrically connected to the circuit 24 of the receptacle 14 via wires, electric cords, a flex circuit, or other equivalent interconnection means. However, in alternative embodiments, the interface 30 may be disposed substantially within the housing 16.

The token receptacle 14 can be configured to be permanently or removably attached to any suitable external device, such as any suitable device associated with, for example, secure communications products to encrypt governmental communications/information that may be transferred, data logging applications for transport of data to/from a remote station, access control to electronic systems or to facilities, carrying a cash value (e.g., cashless vending), and crypto-ignition keys, or CIKs.

As can be seen in FIGS. 1, 2, and 5, an electronic token device 12 includes a non-conductive enclosure 32 (which may also be thought of and referred to as the “body” of the token device 12) having a distal end 34 and a proximal end 36. In some embodiments, the enclosure 32 of the token 12 may be molded plastic for increased strength, durability, and overall ruggedness. The token 12 is configured and arranged for insertion into the channel 18 of the token receptacle 14. Particularly, the token 12 is configured and arranged to slidingly engage the channel 18 and, upon full insertion, engage the contact tips 28 of the plungers 62 overmolded and integrated into the housing 16 of the token receptacle 14. Near the proximal end 36, the token 12 can include a head portion having a stop surface, e.g., a shoulder portion 38. When the token 12 is inserted into the channel 18, the stop or shoulder portion 38 may substantially abut a stop edge or other travel limiter of the token receptacle housing 16, such that the shoulder portion 38 and stop edge determine the final, or fully inserted, position of the token 12 into the channel 18. In particular, the token 12 may include a stop portion 38 for contacting a travel limiter on the token receptacle 14, wherein the stop portion 38 and travel limiter are dimensionally configured to define full insertion of the token 12 into the receiver channel 18 at a position along the insertion path at which each of the contact tips 28 of the plurality of spring-loaded probe contacts 26 is spring driven into contact with and received at a corresponding one of the electrical contacts 40 of the token 12.

The token 12 includes a circuit disposed in and supported by the enclosure 32. The circuit may be configured the same as a circuit in electronic token systems disclosed in prior patents, such as U.S. Pat. Nos. 4,752,679 and 4,578,573 mentioned above, which were previously incorporated herein by reference. For example, the token 12 may include a non-volatile, reprogrammable memory.

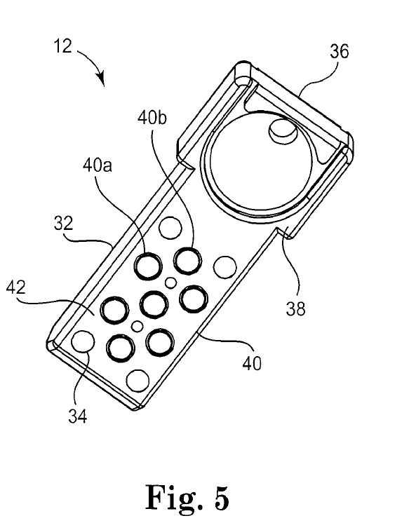

On one side of the token 12, illustrated in FIG. 5 and referred to herein as the contact surface 42, the token 12 comprises one or more electrically conductive contacts 40, arranged, preferably in a generally planar array, and configured such that when the token 12 is fully inserted into the channel 18, the contacts 40 engage the corresponding contact tips 28 of the plungers 62 of the housing 16. The contacts are then electrically coupled to the circuit disposed within the enclosure 32. Since the contacts 40 will generally be exposed, the contacts may be made from a generally rugged or long-lasting material, such as brass. The contacts 40 may be arranged in a generally staggered, sequential arrangement, facilitating “last on, first off” contact with the contact tips 28 of the plungers 62 as the token 12 is inserted into the channel 18. Such an arrangement can be used to assure that proper contact is made prior to power-up of the token 12, i.e., the last contact(s) to mate during insertion completes the power circuit. For example, as seen in FIG. 5, contact 40a may be one contact of a pair of contacts 40a, 40b for receiving power from corresponding probes 26 with contact 40b not making an electrical connection to a corresponding probe 26 until the token 12 is fully inserted.

In use, the token 12 is inserted into the channel 18 of the receptacle 14, whereby the distal end 34 of the token 12 is inserted in either the distal end 20 or proximal end 22 (in a reversible receptacle) of the receptacle 14. In contrast to prior spring-loaded probe systems, wherein the mating direction of the token device is axially-oriented with the spring compression direction, the probe spring action is generally orthogonal to the insertion direction; that is, each of said probe contacts has a plunger 62 movable by spring action in a direction generally orthogonal to the planar array of electrical contacts 40 on an inserted token. Because the token 12 slidingly engages with the channel, the contacts 40 of the token 12 cause a side-loading that presses the plungers of the spring-loaded probes 26 against their respective barrels 60 over a wide or enhanced contact area 66, resulting in a lower contact resistance without having to use internal biasing techniques, which add cost, complexity, and size to the spring-loaded probes 26. Additionally, by inserting the token 12 into the channel 18 of the receptacle 14 substantially orthogonal to one or more of the guiding surfaces 21 of the token receptacle 14, the token 12 creates a sweeping action that shoves debris from the channel 18 and further creates a wiping action of the channel upon exit from the token receptacle 14.

Upon full insertion of the token 12, the stop or shoulder portion 38 generally abuts an insertion/travel limiter, such as an edge of the token receptacle 14, preventing the token 12 to be inserted further. This may be referred to herein as the “full insertion” or “activation” position. In this position, each of the contacts 40 is electrically coupled with a corresponding spring-loaded probe 26. In some embodiments, a user will feel a tactile or hear an auditory feedback when the token 12 enters into the “full insertion” position. For example, this may be achieved by recessing the contacts 40 slightly below or into the contact surface 42. Thus, each probe 26 has a travel distance to reach the corresponding contact 40 after full insertion achieves the desired alignment of probes 26 and corresponding contacts 40.

There are several advantages for an electronic token data carrier system having an electrical/electronic token device and an intelligent token receptacle, wherein the token 12 slidingly engages with the token receptacle 14 and uses spring-loaded probes rather than “bent metal” and/or flexible or resilient metal contacts. Particularly, an edge connector electronic data carrier system 10 according to the present disclosure can be easily cleaned without endangering bent metal or metal “tongue” contacts; there are fewer crevices for holding dirt, dust, debris, viscous liquids, or other elements hazardous to the system 10. Furthermore, because the token 12 slidingly engages with the token receptacle 14, the token insertion creates a “sweeping” effect that wipes out debris from the channel 18, thereby cleaning the channel 18 with every insertion and exit. In such embodiments, the token 12 may be configured such that the length of the token 12 that is inserted into the channel 18 is approximately the same as or greater than the length of the channel 18. As such, with each insertion, the token 12 sweeps or drives any debris entirely from the channel 18. Furthermore, in some embodiments, a sweeping surface may be provided at the distal end 34, such as a portion of the distal surface of the token 12, or on a portion of the contact surface 42 and can be made of a slightly resilient material providing an enhanced sweeping feature.

This wiping action may be enhanced by configuring the inner, leading edge of a token with a wiping edge. The wiping edge may in one embodiment be made of a resilient material configured to wipingly engage the channel 18 during key insertion. The resilient material may be the material from which the entire token enclosure 32 is made, a layer of such resilient material forming the lower contact surface 42 of the token 12 at which contact 40 are present (i.e., the enclosure 32 is a sandwich with the resilient material in a layer forming the lower contact surface 42 that lies against the channel 18 bottom surface), or an insert of resilient material at the leading or wiping edge.

Additionally, bent metal contacts are subject to wear and tear, not only because of the mechanical contact, but also because the contacts are exposed to an outside environment without protection. Spring-loaded probes, as used according to the present disclosure, are less subject to wear and tear and have fewer crucial components that are exposed to the outside environment. Also, the internal real-estate space of a host device can oftentimes by very precious; an edge connector electronic data carrier system 10 according to the present disclosure can be configured to be small and compact and does not require any internal space of the host device.

As yet a further advantage, the spring-loaded probes 26 can provide retention for the token 12 when the token is inserted into the channel 18. Because the probes inherently create a force generally normal to the contact surface of the token 12, the probes can be adjusted or customized, by specifying different spring forces, even on a probe-by-probe basis, to provide a selected amount of friction between the token 12 and the channel 18 walls so that the inserted token 12 is not unintentionally ejected from the token receptacle 14. In some embodiments, retention of the token 12 can be enhanced by the use of detents in the token 12 or channel 18. Furthermore, the material of the housing 16 of the receptacle 14 can be selected to provide or enhance retention. In another embodiment, at least one probe 26 is larger and/or has a stronger bias spring or its corresponding contact 40 is more deeply recessed to so that the probe/contact combination provides a detent.

Although the present invention has been described with reference to preferred embodiments, persons skilled in the art will recognize that changes may be made in form and detail without departing from the spirit and scope of the invention.

We claim:

1. An electronic token system for data exchange with a host device comprising:
a token receptacle operably connected to the host device, said receptacle having a housing with a receiver channel;
a portable token for removable insertion in the receiver channel on an insertion path defined by at least one receiver-channel guide surface, said token comprising:
a data exchange circuit supported in the enclosure; and
a plurality of electrical contacts in a planar array exposed on a contact surface of the token, in operable electrical coupling with the data exchange circuit;
a plurality of spring-loaded probe contacts mounted in the token receptacle, each of said probe contacts having a plunger movable by spring action in a direction generally orthogonal to the planar array of electrical contacts on an inserted token and having a contact tip for receipt at a corresponding one of the electrical contacts in the planar array; and
a stop on the portable token for contacting a travel limiter on the token receptacle, the stop and travel limiter being dimensionally configured to define full insertion of the token into the receiver channel at a position along the insertion path at which each of the contact tips of the plurality of spring-loaded contacts is spring driven for engagement at a corresponding one of the electrical contacts in the planar array.

2. The electronic token system of claim 1, wherein the system has an insertion path defined by an opposed pair of receiver-channel guide surfaces.

3. The electronic token system of claim 2, wherein the token is configured to, upon insertion into the insertion path, clear debris from the receiver channel.

4. The electronic token system of claim 1, wherein the plurality of electrical contacts in the planar array are configured so that contacts assigned to receive power delivered into the token do not receive a corresponding one of the spring loaded contacts until the token in fully inserted.

5. The electronic token system of claim 1, wherein the contact tips of the plurality of spring-loaded probe contacts is substantially hemi-spherical having a radius r.

6. The electronic token system of claim 5, wherein the spring-loaded probe contacts are mounted in the token receptacle such that only a portion of the contact tip having an axial length of less than r extends beyond the surface of the housing in the receiver channel.

7. The electronic token system of claim 1, wherein the token slidingly engages the receiver channel and, upon insertion of the token into the receiver channel, the plurality of electrical contacts of the token create side-loading of the respective, corresponding spring-loaded probe contacts to create an enhanced electrical contact between the components of each spring-loaded probe.

8. The electronic token system of claim 1, wherein at least one spring-loaded probe provides a retention force against an inserted token for retaining the token within the receiver channel.

9. The electronic token system of claim 1, wherein the insertion path has a distal end and a proximal end and the token can be inserted from either end.

10. The electronic token system of claim 9, wherein the length of at least a portion of the token is substantially the same length as the receiver channel.

11. The electronic token system of claim 10, wherein the token is configured to, upon insertion into either the proximal or distal end of the insertion path, clear debris from the receiver channel by pushing the debris out the other of the proximal or distal end of the insertion path.

12. The electronic token system of claim 1, wherein the token receptacle is generally external to the host device.

13. An electronic token system for data exchange with a host device comprising:
a token receptacle operably connected to the host device, said receptacle having a housing with a receiver channel;
a portable token for removable insertion in the receiver channel, said token comprising:
a data exchange circuit supported in the enclosure; and
at least one electrical contact exposed on a generally planar contact surface of the token, in operable electrical coupling with the data exchange circuit;
at least one spring-loaded probe contact mounted in the token receptacle, the at least one probe contact having a plunger movable by spring action in a direction generally orthogonal to the contact surface on an inserted token and having a contact tip for receipt at a corresponding one of the electrical contacts on the contact surface.
